(19) United States
(12) Patent Application Publication
(10) Pub. No.: US 2021/0229536 A1
(43) Pub. Date: Jul. 29, 2021

(54) Portable Temporary Fabric Top Tensioning Bar

(71) Applicant: Tina M. Rusk, Myakka City, FL (US)

(72) Inventor: Tina M. Rusk, Myakka City, FL (US)

(21) Appl. No.: 16/752,656

(22) Filed: Jan. 26, 2020

(51) Int. Cl. B60J 7/12

(52) U.S. Cl. CPC B60J 7/1243

(57) ABSTRACT

The present invention provides an adjustable bowed bar assembly for use with a utility vehicle having opposite tubular frames. The bar includes a collapsible feature and a latch release mechanism with unlimited adjustments. The mechanism has a support bar and adjustable hinge coupled to a second support bar and an adjustable hinge that when combined form a bowed assembly that fit between adjacent tubular bars utilizing coupled claws at opposing ends for tensioning the cover material. The cover material rests atop the canvas support frame with no permanent fastening or additional components required.

### FIELD OF THE INVENTION

The present disclosure relates generally to a portable, foldable, temporary, fabric tensioning, water wicking system for fabric material covers installed on a utility vehicle.

### BACKGROUND OF THE INVENTION

The sport utility vehicle has been around for well over 75 years and yet today remains one, if not the most popular vehicles of choice.

As the fabric tops for these SUV's have evolved, one large problem still remains, and that is the wear and tear of the fabric due to the elements. As the sun heats the fabric top it will give and stretch, then a good afternoon shower will leave gallons of rainwater puddled in the fabric. Trying to remove the water usually, never turns out well. Even your $1,000.00 fabric tops still only have a 3-5-year life span. Add all the elements and the life span lessons, not to mention that it doesn't only stretch the fabric but the stitching that holds the seams together and with that will come more leaks.

U.S. Pat. No. 8,240,743 shows a one-piece rigid bar, with a bow shape to it, that is mounted on the Jeep Wrangler support bars, and the soft top lays on top of it. The claim and field of invention is an apparatus designed for reducing noise by the flapping of the top while driving. The design is intended for the apparatus to permanently remain attached to the vehicle.

SFK Manufacturing, LLC produced the Top Prop. This product has been sold by Quadratec for many years. Again, this product is a single apparatus and designed to be permanently attached to your vehicle. It is claimed that the apparatus is mainly designed for the flapping of the top while driving, yet it is also suggested that it will force water off the top. In order to install this device, you must either use clamps or drill holes in the roll bars, regardless the design gives no other option but to cut holes in your roll bar covers. Roll bar covers range anywhere from $60.00-$300.00. This design is only applicable for years 2007-to present.

Rugged Ridge created the “Acoustic Brief,” which is designed solely for trying to eliminate roads noise as they state, “This unique design drastically reduces road noise within the cab of your jeep.” It will collect water when it rains.

Below is listed, yet not intended to be exhausted, which has been designed to try and solve the major problem in the vehicle fabric top industry.

U.S. Pat. No. 5,207,262 May 4, 1993 Steven Rushford U.S. Pat. No. 6,948,761 Sep. 27, 2005 Brian Haack, Louis Simko, Gary Mobley

U.S. Pat. No. 7,334,830 Ross Weldy Feb. 26, 2008

U.S. Pat. No. 7,828,364 Mark Causey Nov. 9, 2010

U.S. Pat. No. 7,905,536 Shaun Yue Mar. 15, 2011

U.S. Pat. No. 6,793,273 James Tuerk Sep. 21, 2004

U.S. Pat. No. 6,957,842 Bradley Garska Oct. 25, 2005

U.S. Pat. No. 7,240,960 Robert Fallis, Michael Willard Jul. 10, 2007

U.S. Pat. No. 7,246,841 Christopher Dilluvio Jul. 24, 2007

U.S. Pat. No. 9,056,542 Charles Schmeichel Jun. 16, 2015

U.S. Pat. No. 10,399,421 Anthony Smith, Dean Mettler Sep. 3, 2019

### SUMMARY OF THE INVENTION

The present invention provides an inventive solution and solves the water build up problem for covers formed of either hard, soft or semi-rigid materials, by providing an easy temporary attachment system that gives the ability to wick water and is a portable and temporary solution that can be stored in the vehicle.

### FIGURE REFERENCES

100—Lower Tensioning Bar
101—Upper Tensioning Bar
102—Lower Tensioning Bar Claw
103—Upper Tensioning Bar Claw
104—Tensioning Bar Joint
105—Hinge Unit
106—Portable Temporary Fabric Top Tensioning Bar
107—Utility Vehicle Support Bars

### BRIEF DESCRIPTION OF THE DRAWINGS

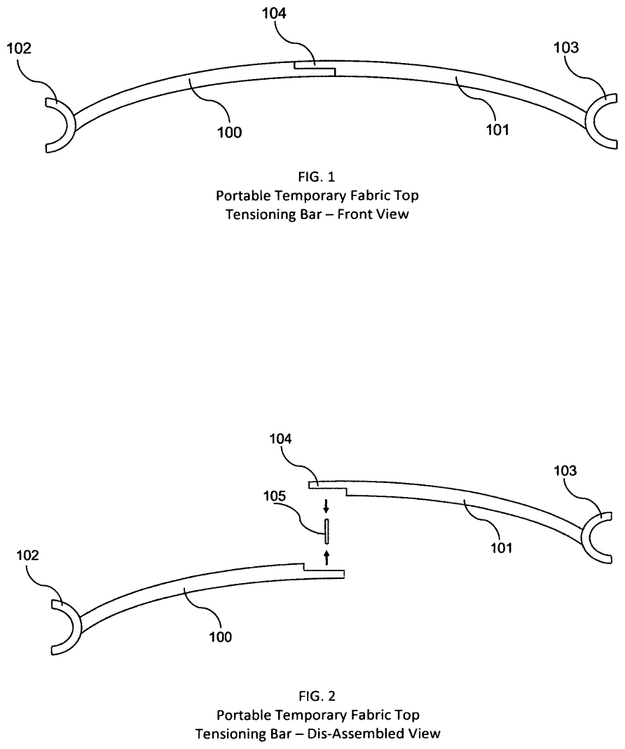

In another embodiment, as shown in FIGS. 1, 2, and 3, the assembly can further include:

FIG. 1 Front View, herein a lower tensioning bar 100, such that can be attached to an upper tensioning bar 101 through the utilization of the tensioning bar joint 104.

FIG. 2 Dis-Assembled View, herein the first lower tensioning bar 100 is mounted to an upper tensioning bar 101 through the hinge unit 105;

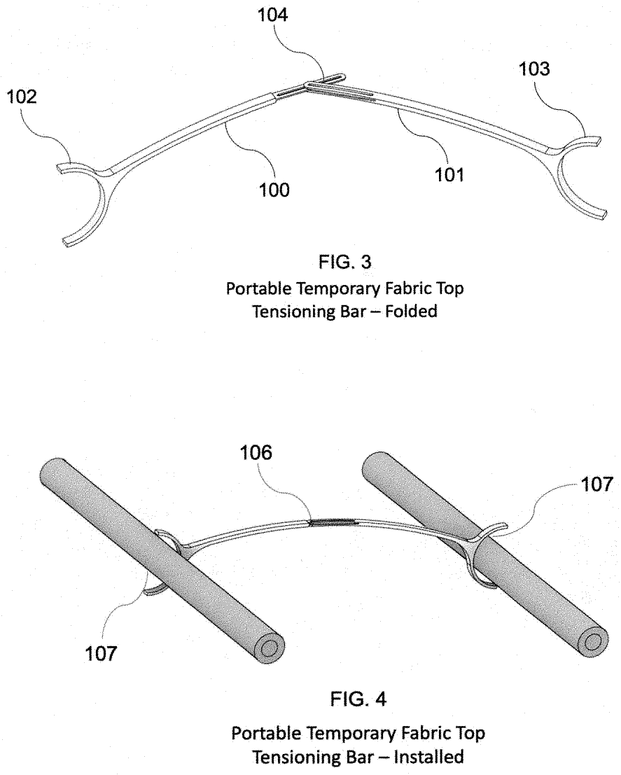

FIG. 3 Folded, herein the Lower Tensioning Bar Claw 102 and 103 are mounted on utility vehicle, FIG. 4 Installed, utility vehicle support bar 107, such that the Lower Tensioning Bar Claw 102 and the Upper Tensioning Bar Claw 103 sides are mounted to the utility vehicle support bar structure 107.

FIG. 4 Installed, herein support bar 106, wherein mounted to utility vehicle support bars 107, right and left, such that forming the bowed assembly.

1. The portable temporary fabric top tensioning bar, wherein comprising of at least two claws that are adjustable by different sized inserts for different model years.

2. The portable temporary fabric top tensioning bar, wherein the tensioning bar is hinged such that allowing it to be rotatable and foldable.

3. The portable temporary fabric top tensioning bar, whereby the tensioning bar is adjustable and lockable by a tensioning device, such that allowing a temporary fixed location.
